(19) United States
(12) Patent Application Publication
(10) Pub. No.: US 2004/0250103 A1
(43) Pub. Date: Dec. 9, 2004

(54) Magnetic disk apparatus

(76) Inventor: Teruhisa Yokosawa, Nagano (JP)

Correspondence Address: RABIN & Berdo, PC, 1101 14TH STREET, NW, SUITE 500, WASHINGTON, DC, 20005, US

(21) Appl. No.: 10/792,277

(22) Filed: Mar. 4, 2004

(30) Foreign Application Priority Data
Mar. 25, 2003 (JP) 2003-081933

(51) Int. Cl. G06F 12/14

(52) U.S. Cl. 713/193

(57) ABSTRACT

A magnetic disk apparatus having at least a decryption key stored in advance in a storage. The storage, including a magnetic disk medium, is provided in a case. The magnetic disk medium has digital AV information digitally compressed and encrypted, and recorded therein. The digital AV information is decrypted using the decryption key. The digital AV information is decompressed successively inside the magnetic disk apparatus in response to an instruction to reproduce the recorded digital AV information, and a reproduction signal of digital AV information as a decompression result is output. The magnetic disk apparatus is configured in such a manner that at least information recorded on the magnetic disk medium is destroyed in response to an attempt to remove the magnetic disk medium from a shaft of a spindle motor for holding and rotating the magnetic disk medium.

### BACKGROUND OF THE INVENTION

1. Field of the Invention

The invention relates to a magnetic disk apparatus that makes it possible to record and reproduce copyrighted digital audio and video information while protecting its copyright safely.

2. Description of the Related Art

In the drawings, the same or equivalent components are denoted by the same reference symbols.

Digital audio and video information (hereinafter abbreviated as digital AV information) can be acquired from recording media such as DVDs, the Internet, digital broadcasts, etc. However, once stored as digital information, such digital AV information can be copied: its copyright may not be protected.

In particular, magnetic disk apparatuses that are mainly used as external storage of computers are suitable for storage of digital AV information because they have high write/read speeds and large storage capacities. However, magnetic disk apparatuses until now have not been used to record copyrighted digital AV information, because no measures have been taken for the copyright protection; that is, writing of data and reading of all the recorded data are freely performed (permitted) according to an instruction from a computer to enable safe storage of programs and data of the computer. Therefore, magnetic disk apparatuses have not been used to record copyrighted digital AV information.

In the above circumstances, in recent years, techniques for preventing illegal copying of copyrighted digital AV information have been proposed. For example, JP-A-11-161165 at page 4 discloses a technique for preventing illegal copying of digital AV information that is handled in an information processing apparatus in which information is exchanged between a storage device and an arbitrary peripheral device and between peripheral devices via a prescribed information transmission line such as a bus. Each of the storage device and the peripheral devices is provided with at least one of a function of authenticating the device with which information is to be exchanged via the information transmission line and a function of encrypting and decrypting information is to be exchanged via the information transmission line. All data to go through the data transfer line such as a bus are encrypted and an encryption key is exchanged in an encrypted state. In this manner, data are transmitted safely.

JP-A-2000-298942 at page 3 discloses a disk storage apparatus having a function to prevent illegal copying of digital AV information. Identification data specific to the disk storage apparatus is stored in advance in a storage area of a non-rewritable disk or an internal memory. When receiving a particular command from a host system such as a personal computer in an operation of recording ordinary user data, the disk storage apparatus reads the identification data from the storage area and outputs it. When the host system stores AV content data such as video data or audio data in the disk storage apparatus, the identification data is read out. In this manner, the disk storage apparatus can be identified and hence limitless copying of content data can be prevented.

Further, a system having the above disk storage apparatus and host system is provided with an encrypted data generating means. This generating means uses the identification data for generating encryption key data to be used for encrypting content data that is to be recorded in the disk storage apparatus. Since content data is encrypted and recorded for each disk storage apparatus, reproduction of content data recorded in a particular disk storage apparatus can be prevented when another host system accesses that disk storage apparatus. Limitless copying of content data can thus be prevented.

However, even copyrighted digital data that is protected by the above-mentioned techniques of JP-A-11-161165 and JP-A-2000-298942 can be read out illegally by the following methods.

In a system using the technique of JP-A-11-161165, that is, in a system in which data is transferred in such a manner that the data is encrypted when supplied from a storage device to the bus of a computer, plain data (i.e., non-encrypted data) are stored in the storage device. Copyrighted digital AV data can be read illegally by taking the storage device apart and leading out signal lines.

In the method disclosed in JP-A-2000-298942, in which ID data specific to a disk storage apparatus is stored in a redundant area (replacement sectors) on the disk or an IC memory (EEPROM) and managed by a host system, a copyright can be protected as long as the apparatus is used in an ordinary manner.

However, the ID data can be analyzed by taking the disk storage apparatus and reading signals from signal lines of the IC memory in the apparatus. Even if the ID data is recorded on the disk, the ID data can be analyzed by analyzing signals on signal lines that connect data channels and a control CPU in the apparatus with a logic analyzer.

Once the ID data is analyzed successfully, codes can be decrypted easily. Copyrighted digital AV information can be decrypted and copied to another recording apparatus.

Decrypting copyrighted digital AV information using signals on signal lines is now being conducted actually in game machines. If copyrighted digital AV information comes to be recorded on disk storage apparatus, it may well be analyzed.

As described above, in systems with sections having non-encrypted data, breaking the protective measure is possible by taking the section apart and obtaining signals from it.

### OBJECT AND SUMMARY OF THE INVENTION

The invention has been made in view of the above circumstances in the art. An object of the invention therefore is to provide a magnetic disk apparatus that lowers the risk of illegal decryption of copyrighted digital AV information by concentrating sections having information that enables decryption of highly secret codes on a magnetic disk medium, and in which data recorded on the magnetic disk medium are broken if attempts are made to decrypt copyrighted digital AV information illegally by a certain method.

To attain the above object, the invention provides a magnetic disk apparatus wherein at least a decryption key (as one of pieces of specific information 200) is stored in advance in a storage means. Such storage means includes a magnetic disk medium (2) incorporated in the magnetic disk apparatus. After digital AV information (10A), which has been compressed digitally and encrypted, is recorded on the magnetic disk medium, decryption of the digital AV information using the decryption key and its decompression are performed successively inside the magnetic disk apparatus. The decryption and decompression is in response to an instruction to reproduce the recorded digital AV information. A reproduction signal (digital AV signal 100) of digital AV information as a decompression result is output (to a digital AV information apparatus 03).

The magnetic disk apparatus may be such that the decryption key is stored in (a specific information area 20 of) the magnetic disk medium, A decryption and decompression circuit (a digital AV information decryption circuit 17, a digital AV information decompression circuit 18, etc.) for decrypting and decompressing the digital AV information may be disposed in the same case (1) as is the magnetic disk medium. The decryption and decompression circuit may be disposed between the magnetic disk medium and a surface of the case to which a spindle motor (5) for holding and rotating the magnetic disk medium is fixed.

The magnetic disk apparatus may be configured in such a manner that at least information recorded on the magnetic disk medium is destroyed if the case is opened. The magnetic disk apparatus also may be configured in such a manner that at least information recorded on the magnetic disk medium is destroyed if it is attempted to remove the magnetic disk medium from a shaft of a spindle motor for holding and rotating the magnetic disk medium.

The magnetic disk apparatus may be such that a surface, to contact the magnetic disk medium, of a clamp body (spindle clamp 6) for clamping the magnetic disk medium to the shaft of the spindle motor is formed with a groove (6a). A liquid (corrosive liquid LQ) or a gas capable of destroying a recording surface of the magnetic disk medium may be confined in the groove, and if an attempt is made to detach the clamp body so as to remove the magnetic disk medium from the shaft of the spindle motor the liquid or the gas flows out of the groove and destroys the recording surface of the magnetic disk medium. If a liquid confined in the groove it may be an acid.

According to a concept of the invention described below, a copyright protection function is incorporated into a magnetic disk apparatus itself for recording digital AV information. The copyright protection is based on a process that original digital AV information or digitally compressed digital AV information is encrypted by using an encryption key and then transferred, and the original digital AV information is restored when necessary by using a decryption key that corresponds to the encryption key.

Various encryption techniques are now available, and currently are considered effective because an enormous amount of time is needed to break them. Therefore, important subjects of the copyright protection are (1) how to hide an encryption key and a decryption key from persons other than a copyright managing party, and (2) how to output audio or video while preventing decrypted digital AV information from being copied.

First, with respect to how to render an encryption key and a decryption key hard to read, in the invention an encryption key and a decryption key as specific information of a magnetic disk apparatus, or a magnetic disk medium are written to the magnetic disk medium inside the magnetic disk apparatus.

This increases the safety because any numbers of encryption keys and decryption keys can be recorded on the magnetic disk medium. The encryption key and decryption key as specific information should be made non-rewritable once written.

The encryption key of the specific information that is recorded on the magnetic disk medium is transferred to a copyright management server that manages copyrighted digital AV information in such a manner as not to be recognized by other persons (in the embodiment of the invention, by using a cell phone (radio communication) that performs encryption processing for protection against eavesdropping).

The copyright management server encrypts copyrighted digital AV information using a code (i.e., the transferred encryption code) that can be decrypted only by using the decryption key that is one of the pieces of specific information that are held by the transfer source magnetic disk apparatus. The encrypted digital AV information is transferred to the magnetic disk apparatus and recorded there.

The recorded digital AV information can be viewed as an image or listened to as music by decrypting it using the decryption key of the specific information held by the magnetic disk apparatus.

Since the specific information (encryption key and decryption key) stored in the magnetic disk apparatus is used, the encrypted digital AV information recorded on the magnetic disk medium cannot be viewed or listened to by decrypting it even if it is read or copied as long as the specific information is unknown. The copyright can thus be protected safely.

It is meaningless if the encryption key and the decryption key as the important specific information are read out easily in response to a read instruction from a computer. Unlike in the case of ordinary data, it is necessary to prevent the specific information from being physically written to or read from the magnetic disk medium even if an instruction to do so comes from a computer.

In the invention, to prevent the specific information from being written or read by a computer, a CPU that is incorporated in the magnetic disk apparatus performs a control so that the specific information cannot be recognized by a computer like management areas such as servo areas on a magnetic disk.

Even if the digital AV information is managed strictly in the above-described manner, it is meaningless if the digital AV information is hacked when it is finally output as an image. In view of this, in the invention, the digital AV information that was compressed according to MPEG-2 or the like is decompressed immediately after it is decrypted.

This is because decompressed AV information has an enormous amount of data and hence is hard to record as it is, and an attempt to record the decompressed AV information will result in a failure. That is, since ordinary compression methods such as MPEG-2 employ irreversible conversion, if compressed data are decompressed and then compressed again digital AV information (image or sound) is deteriorated, that is, original digital AV information cannot be restored.

The safety of the digital AV information is increased by incorporating the copyright protection function into the magnetic disk apparatus itself in the above-described manner. However, a hacker or a cracker attempts to read out the encryption key and the decryption key by taking the magnetic disk apparatus apart and obtaining signals and hence decrypted digital AV information from internal electrical circuits or by reading data from the magnetic disk medium by another method.

As a countermeasure against such attempts, in the invention, the magnetic disk apparatus is provided with a mechanism for preventing electrical signals from being taken out by dismantling the magnetic disk apparatus and a mechanism for destroying information recorded on the magnetic disk medium.

Specifically, in the invention, unlike in ordinary magnetic disk apparatus, first, the signal processing section is disposed inside the case in which the magnetic disk medium and the magnetic head are housed, to prevent electrical signals from being taken out of printed circuit boards or the pins of LSIs.

In particular, the safety is further increased by disposing the signal processing section in the narrow space between the magnetic disk medium and the surface of the case to which the spindle motor is fixed.

However, even in this case, the digital AV information can be taken out by opening the case and removing the magnetic disk medium, leading out signal lines from a target printed circuit board or the pins of a target LSI, and attach the magnetic disk medium again.

To cope with such attempts, in the invention, the magnetic disk apparatus is provided with the function of destroying information recorded on the magnetic disk medium if someone attempts to remove the magnetic disk medium. The magnetic disk medium is fixed to the shaft of the spindle motor via clamps. The clamps are modified so that information recorded on the magnetic disk medium is destroyed if someone attempts to remove the magnetic disk medium.

For example, the surface, to contact the surface of the magnetic disk medium, of each clamp is formed with a groove and a liquid or gas is confined in the groove. Although in a clamped state the liquid or gas is tightly confined by the clamp and the magnetic disk medium, when someone attempts to remove the magnetic disk medium the liquid or gas is scattered around and destroys the magnetic disk medium.

In current magnetic disk apparatus, the magnetic head flies over the magnetic disk medium at a very small height of 20 nm or less. Therefore, only slight contamination disables writing and reading. In particular, if the liquid or gas is acidic, it corrodes the magnetic disk medium severely and hence is highly effective.

### BRIEF DESCRIPTION OF THE DRAWINGS

FIG. 1 is a block diagram showing the configuration of the main part of a system including a magnetic disk apparatus according to an embodiment of the invention;

FIG. 2 shows a flow of data according to the invention of the magnetic disk apparatus shown in FIG. 1;

FIG. 3 shows the structure of a recording surface of a magnetic disk medium shown in FIG. 1;

FIG. 4 is a sectional view of the main part of the magnetic disk apparatus shown in FIG. 1;

FIG. 5 is a perspective view of a spindle clamp shown in FIG. 4, and

FIG. 6 is a sectional view of the spindle clamp and a tube containing a corrosive liquid.

### DESCRIPTION OF THE PREFERRED EMBODIMENTS

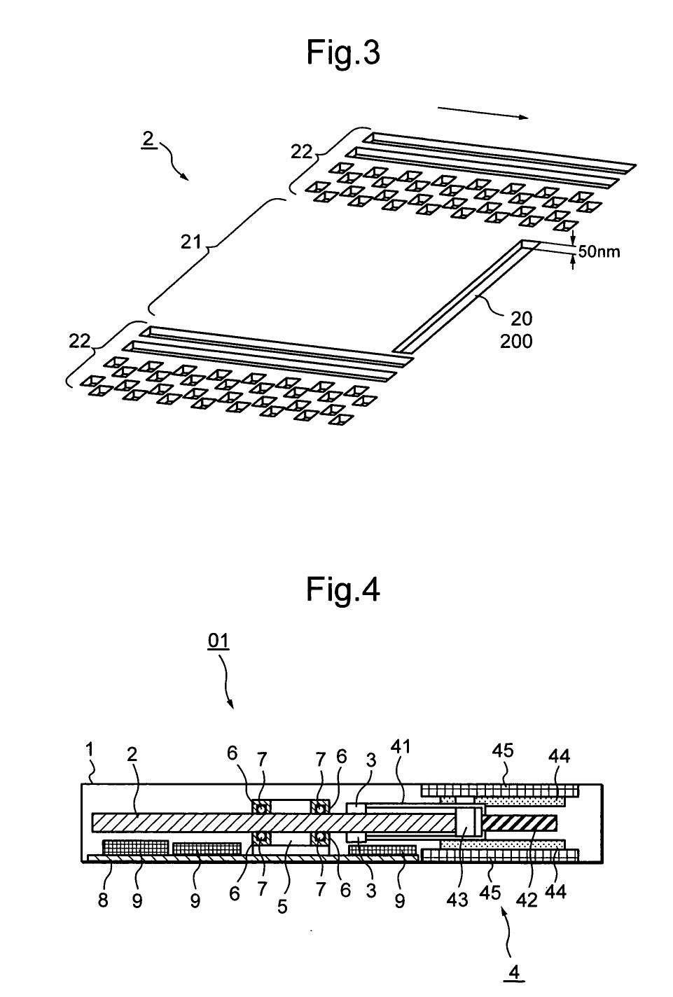

FIG. 3 shows the structure of a recording surface of a magnetic disk medium 2 according to an embodiment of the invention. In FIG. 3, reference numeral 21 denotes one of data areas that are formed radially at regular intervals on the recording surface of the magnetic disk medium 2 and numeral 22 denotes servo areas formed on both sides of the data area 21. Reference numeral 20 denotes a specific information area that is formed inside the data area 21. Specific information 200 (in this embodiment, an encryption key and a decryption key) of a magnetic disk apparatus 01 (or magnetic disk medium 2) is stored in the specific information area 20.

In this embodiment, the magnetic disk medium 2 employs a plastic substrate. A plastic material is injection-molded by using a stamper whose surface is formed with asperities, whereby servo areas 22 (for writing of servo information) and specific information areas 20 (for writing of specific information 200) in which to store non-rewritable information, are formed on the surface of the plastic substrate at a depth of, for example, 50 nm.

A primer coat layer, a magnetic layer, and a protective film are formed on the plastic substrate, and a lubricant is applied to the protective film, whereby a plastic magnetic disk medium 2 is formed. After servo writing is performed on the magnetic disk medium 2, specific information 200 is written to the recessed specific information areas 20.

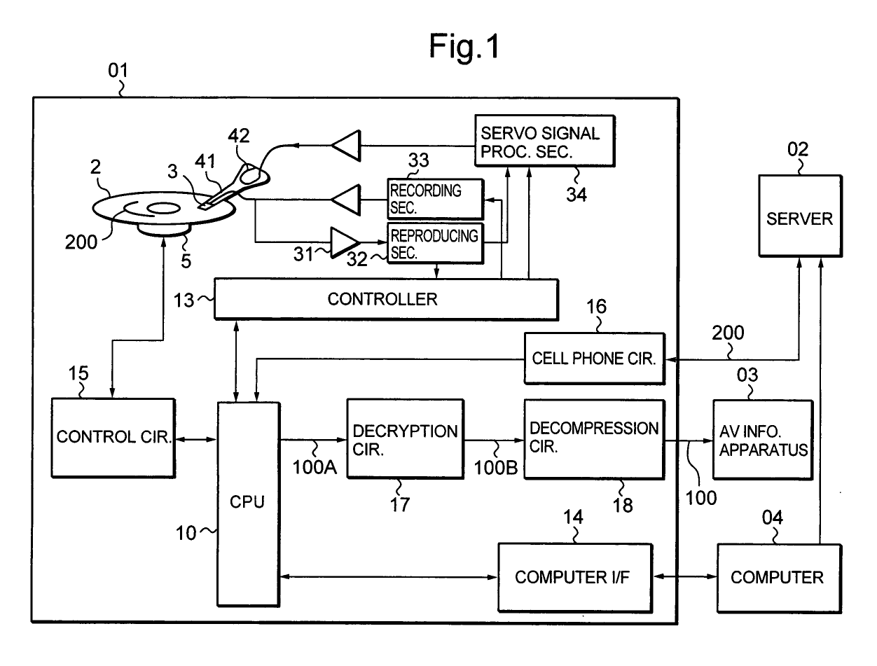

FIGS. 1 and 4 are a block diagram and a sectional view, respectively, showing the configuration of the main part of a magnetic disk apparatus 01 according to an embodiment of the invention. As shown in FIGS. 1 and 4, a magnetic disk medium 2, to which specific information 200 has been written according to the invention, is rotated while mounted on the shaft of a spindle motor 5 that is controlled by a spindle motor control circuit 15.

A magnetic head 3 for writing and reading data to and from the magnetic disk medium 2 is attached to one end of a rotor arm 41 of a VCM motor. Attached to the other end of the VCM motor is a coil 42 for receiving a drive force in a magnetic field that is formed between confronting magnets 44. The magnetic head 3 scans the surface of the magnetic disk medium 2 while being turned thereon.

Reference numeral 13 denotes a controller for controlling the VCM motor 4 and the magnetic head 3. The controller 13 causes the magnetic head 3 to trace a designated track by varying the current flowing through the coil 42 via a servo signal processing section 34. The controller 13 also controls writing to the magnetic disk medium 2 via a recording section 33, and controls reading from the magnetic disk medium 2 via a reproducing section 32. Reference numeral 31 denotes a head amplifier.

Reference numeral 10 denotes a CPU for controlling the entire magnetic disk apparatus 01. The CPU 10 performs ordinary operations of the magnetic disk apparatus 01 by exchanging data with an external computer or Internet terminal (hereinafter referred to as “computer or the like”) 04 via a computer interface 14 (e.g., SCSI, ATA, USB, or IEEE 1394) in the magnetic disk apparatus 01, while controlling the spindle motor control circuit 15 and the controller 13. The CPU 10 also performs the following operation, which is at the essence of the invention.

According to the invention, a one-chip cell phone circuit 16 serving as a digital radio device, a digital AV information decryption circuit 17, and a digital AV information decompression circuit 18 are provided in the magnetic disk apparatus 01. The CPU 10 transfers, by radio, an encryption key in the specific information 200 to an external copyright management server 02 via the one-chip cell phone circuit 16. And the CPU 10 records, on the magnetic disk medium 2, compressed and encrypted digital AV information 100A that is sent in response from the copyright management server 02 via the Internet or the like.

The CPU 10 causes the digital AV information decryption circuit 17 and the digital AV information decompression circuit 18 to decrypt and decompress the compressed and encrypted digital AV information 100A that is recorded on the magnetic disk medium 2 by supplying reproduction instructions thereto. The CPU outputs a resulting digital AV signal 100 to an external digital AV information apparatus 03 such as a TV receiver, audio apparatus, or the like, so that it can be viewed or listened to.

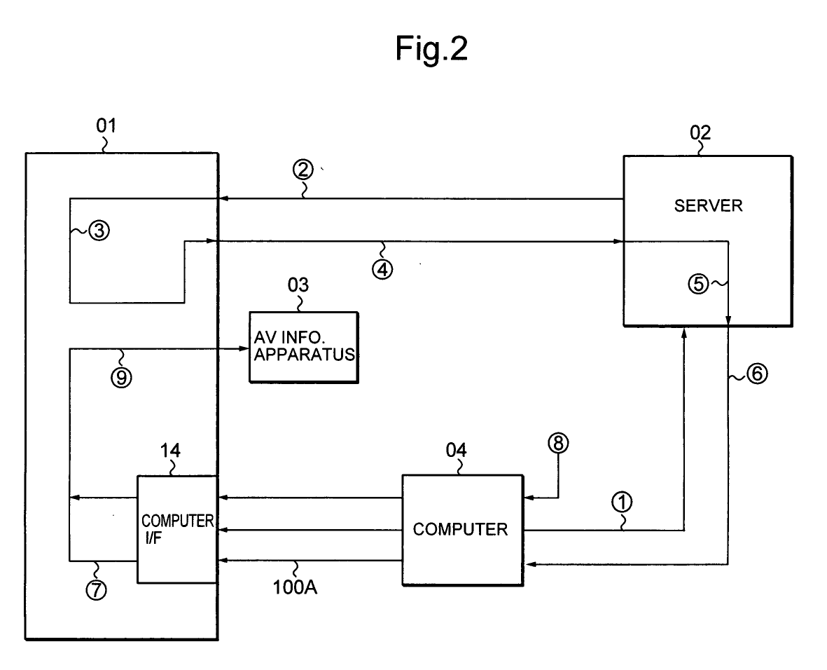

FIG. 2 shows a flow of data according to the invention with the magnetic disk apparatus 01 as the center. Operations according to the invention of the CPU 10 of the magnetic disk apparatus 01 will be described below in order with reference to FIG. 2 as well as FIG. 1.

(1) First, a legitimate user (hereinafter referred to simply as a “user”) of the magnetic disk apparatus 01 selects desired digital AV information via the computer or the like 04. The legitimate user then sends, via the Internet, a download request to a copyright management server 02 that relates to the selected digital AV information. At the same time, the user informs the CPU 10 of the copyright management server 02 to which the download request was sent. At this time, the user informs the copyright management server 02 of a telephone number or an IP address that is necessary for the server 02 to access the magnetic disk apparatus 01, and performs payment processing if a certain fee is necessary.

(2) In response, the copyright management server 02 transfers, by digital radio, a public key to the CPU 10 of the magnetic disk apparatus 01 via the one-chip cell phone circuit 16, without intervention of the user.

(3) The CPU 10 reads the encryption key of the specific information 200 from the magnetic disk medium 2.

(4) The CPU 10 encrypts the encryption key of the specific information 200 using the transferred public key, and transfers, by digital radio, the encrypted encryption key to the copyright management server 02 via the one-chip cell phone circuit 16.

(5) The copyright management server 02 encrypts the digital AV information that was requested by the magnetic disk apparatus 01, by using the transferred encryption key so that the CPU 10 will be able to decrypt it using the decryption key of the specific information 200.

(6) The copyright management server 02 delivers the thus-encrypted and compressed digital AV information 100A to the computer or the like 04, ordinarily via the Internet or the like.

(7) The user causes the CPU 10 of the magnetic disk apparatus 01 to record, on the magnetic disk medium 2, the compressed and encrypted digital AV information 100A that has been delivered to the computer or the like 04.

(8) To view or listen to the digital AV information 100A as an actual image or music, the user causes the computer or the like 04 to issue a reproduction instruction to the CPU 10 with designation of a file name of the desired digital AV information, so that a reproduction signal will be output to the digital AC information apparatus 03.

(9) The CPU 10 reads the decryption key of the specific information 200 from the magnetic disk medium 2, and first causes the digital AV information decryption circuit 17 to decrypt the compressed and encrypted digital AV information 100A using the read-out decryption key.

Then, the CPU 10 causes the digital AV information decompression circuit 18 to decompress resulting decrypted but still compressed digital AV information 100B, whereby a decompressed, that is, reproduced, digital AV signal 100 is output to the digital AV information apparatus 03. As a result, the user can view or listen to the digital AV signal 100 as an image or music.

Since, as described above, the magnetic disk apparatus 01 can handle the encryption key and the decryption key by itself, the copyright of digital AV information can be protected safely as long as the magnetic disk apparatus 01 is dismantled and the encryption key and the decryption key thereby are read out.

However, in addition, the magnetic disk apparatus 01 according to the invention is configured in the following manner so as to prevent reading of the encryption key and the decryption key.

As shown in the sectional view of FIG. 4, a printed circuit board 8 that is mounted with LSIs 9 that serve as the CPU 10 and with the controller 13, the spindle motor control circuit 15, the one-chip cell phone circuit 16, the digital AV information decryption circuit 17, the digital AV information decompression circuit 18, the sections 31-34, etc., is disposed under the magnetic disk medium 2. That is, the printed circuit board 8 is disposed in the narrow space between the magnetic disk medium 2 and the bottom surface of a case 1, to which the spindle motor 5 is fixed.

Therefore, merely removing a cover of the case 1 of the magnetic disk apparatus 01 does not make it possible easily to obtain unprotected electrical signals being processed from the printed circuit board 8 or the pins of the LSIs 9.

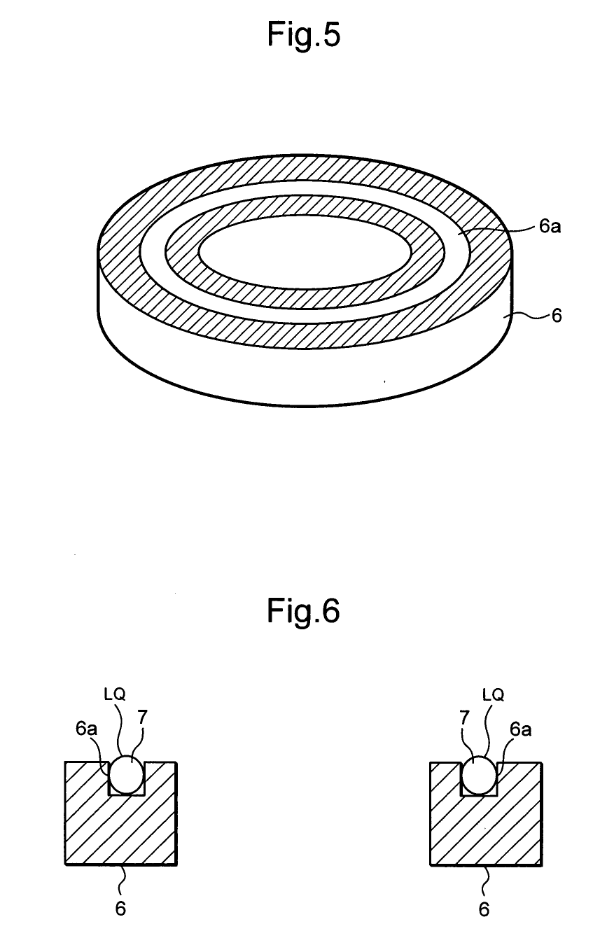

FIG. 5 is a perspective view of a spindle clamp 6 that is used for fixing the magnetic disk medium 2 to the shaft of the spindle motor 5 (see FIG. 4). FIG. 6 is a sectional view of a tube 7 that contains a corrosive liquid and is placed in a groove 6a of each spindle clamp 6.

Each spindle clamp 6 has the groove 6a at a position where it is to contact the magnetic disk medium 2. The tube 7 by which the corrosive liquid LQ is enclosed is set in the groove 6a.

In this embodiment, 1% dilute sulfuric acid as the corrosive liquid LQ is contained in the tube 7. The magnetic disk medium 2 is clamped to the shaft of the spindle motor 5 in such a manner that the tube 7 is sandwiched between spindle clamp 6 and the magnetic disk medium 2. The related members are formed so that the tube 7 is broken upon clamping of the magnetic disk medium 2 and at that time the spindle clamp 6 and the surface of the magnetic disk medium 2 confine the corrosive liquid LQ without leaking it.

With the above configuration, it someone attempts to remove the magnetic disk medium 2 to obtain electrical signals from the magnetic disk medium 2 or the pins of the LSIs 9, the corrosive liquid LQ flows out of the space between the spindle clamp 6 and the magnetic disk medium 2 and causes corrosion and contamination of the surface of the magnetic disk medium 2. The magnetic disk medium 2 cannot be used any more and the digital AV information, the encryption key, and the decryption key that are recorded thereon can no longer be read out.

Even if another magnetic disk medium is mounted on the magnetic disk apparatus 01, copyrighted digital AV information cannot be handled because of absence of an encryption key and a decryption key of specific information. In this manner, copyrighted digital AV information can be protected safely.

Although in the above embodiment the specific information 200 is written to the magnetic disk medium 2, it may be written to another storage means, such as an EEPROM that is provided in the same case that the magnetic disk medium 2 is provided, in place of the magnetic disk medium 2.

In this case, for example, another storage means is disposed at a position that is similar to the positions where the LSIs 9 are located (see FIG. 4), and a measure is taken to make it as difficult as possible to read specific information from it.

As described above, the invention provides a magnetic disk apparatus in which at least a decryption key is stored in advance in one storage means thereof. The storage means includes a magnetic disk medium that is incorporated in the magnetic disk apparatus. After encrypted digital AV information is recorded on the magnetic disk medium, the encrypted digital AV information is decrypted inside the magnetic disk apparatus using the decryption key in response to a reproduction instruction, and a resulting reproduction signal is output. Since the encrypted digital AV information can be decrypted inside the magnetic disk apparatus without outputting the important decryption key to an external apparatus, the safety of the copyright protection of the digital AV information is increased.

Since digitally compressed digital AV information is decompressed inside the magnetic disk apparatus, the risk of copying of the compressed digital AV information is low. Since electrical circuits or LSIs for decryption are hidden in the same case of the magnetic disk apparatus as the magnetic disk medium is provided, the risk that digital AV information being processed is taken out, is reduced. Further, information recorded on the magnetic disk medium is destroyed as soon as the magnetic disk apparatus or the magnetic disk medium is taken apart. This makes removal of the specific information stored in the magnetic disk medium impossible. Even if another magnetic disk medium is incorporated into the magnetic disk apparatus, the magnetic disk apparatus cannot handle encrypted digital AV information because of an absence of a specific encryption key and decryption key. This application corresponds to applicants' Japanese Patent Application Ser. No. 03-081933, filed Mar. 25, 2003, the entire disclosure of which is incorporated herein by reference.

What is claimed is:

1. A magnetic disk apparatus, comprising:
a case;
storage means including a magnetic disk medium, in which at least a decryption key is stored in advance, the magnetic disk medium having digital AV information digitally compressed and encrypted, and recorded therein, wherein the storage means, including the magnetic disk medium, is disposed in said case; and
means for decrypting the digital AV information using the decryption key and decompressing the digital AV information successively inside the magnetic disk apparatus in response to an instruction to reproduce the recorded digital AV information, and outputting a reproduction signal of digital AV information as a decompression result.

2. The magnetic disk apparatus according to claim 1, wherein the magnetic disk apparatus is configured in such a manner that at least information recorded on the magnetic disk medium is destroyed in response to an attempt to remove the magnetic disk medium from a shaft of a spindle motor for holding and rotating the magnetic disk medium.

3. The magnetic disk apparatus according to claim 1, wherein the decryption key is stored in the magnetic disk medium, further comprising in said case a decryption and decompression circuit for decrypting and decompressing the digital AV information.

4. The magnetic disk apparatus according to claim 3, wherein the magnetic disk apparatus is configured in such a manner that at least information recorded on the magnetic disk medium is destroyed if the case is opened.

5. The magnetic disk apparatus according to claim 3, wherein the magnetic disk apparatus is configured in such a manner that at least information recorded on the magnetic disk medium is destroyed in response to an attempt to remove the magnetic disk medium from a shaft of a spindle motor for holding and rotating the magnetic disk medium.

6. The magnetic disk apparatus according to claim 3, further comprising a spindle motor for holding and rotating the magnetic disk medium fixed to a surface of the case, wherein the decryption and decompression circuit is disposed between the magnetic disk medium and said case surface.

7. The magnetic disk apparatus according to claim 6, wherein the magnetic disk apparatus is configured in such a manner that at least information recorded on the magnetic disk medium is destroyed in response to an attempt to remove the magnetic disk medium from a shaft of said spindle motor.

8. The magnetic disk apparatus according to claim 7, wherein a surface, to contact the magnetic disk medium, of a clamp body for clamping the magnetic disk medium to the shaft of the spindle motor is formed with a groove, a liquid or a gas capable of destroying a recording surface of the magnetic disk medium is confined in the groove, and an attempt to detach the clamp body to remove the magnetic disk medium from the shaft of the spindle motor causes the liquid or the gas to flow out of the groove and destroy the recording surface of the magnetic disk medium.

9. The magnetic disk apparatus according to claim 8, wherein the liquid confined in the groove is an acid.
